(19) United States
(12) Patent Application Publication
(10) Pub. No.: US 2013/0315448 A1
(43) Pub. Date: Nov. 28, 2013

(54) SYSTEMS AND METHODS FOR MEASURING LONGITUDINAL BRAIN CHANGE INCORPORATING BOUNDARY-BASED ANALYSIS WITH TENSOR-BASED MORPHOMETRY

(71) Applicants: Evan Fletcher, Davis, CA (US); Charles DeCarli, Sacramento, CA (US); Baljeet Singh, Davis, CA (US); Alexander Knaack, Valley Village, CA (US)

(72) Inventors: Evan Fletcher, Davis, CA (US); Charles DeCarli, Sacramento, CA (US); Baljeet Singh, Davis, CA (US); Alexander Knaack, Valley Village, CA (US)

(21) Appl. No.: 13/851,658

(22) Filed: Mar. 27, 2013

Related U.S. Application Data
(60) Provisional application No. 61/616,854, filed on Mar. 28, 2012.

(51) Int. Cl. G06T 7/20

(52) U.S. Cl. CPC G06T 7/2033
USPC 382/107

(57) ABSTRACT

Systems and methods are provided for computing a longitudinal change in a structure of a brain. The method may include receiving a first image of the brain, wherein the first image is captured at a first time; receiving a second image of the brain, wherein the second image is captured at a second time; aligning the first and second images; generating at least one displacement from a location in the first image back to a corresponding location in the second image; and determining an optimized matching deformation between the first and second images based on an energy function that incorporates spatially varying estimates of a likelihood of tissue edge presence at the location in the first image, wherein the matching deformation is one of the generated displacements.

### CROSS-REFERENCE TO RELATED APPLICATIONS

This application claims the benefit of priority of U.S. provisional patent application Ser. No. 61/616,854, filed Mar. 28, 2012, the contents of which are incorporated herein by reference.

### STATEMENT OF GOVERNMENT INTEREST

This invention was made with Government support under Grant Nos. AG010129 & AG021028, awarded by the National Institute of Health. The Government has certain rights in this invention.

### TECHNICAL FIELD

This application generally relates to measuring longitudinal brain change by combining boundary-based analysis using estimates of prior information about tissue boundaries with tensor-based morphometry.

### BACKGROUND

Detecting biological change in longitudinal pairs of magnetic resonance imaging (MRI) brain images is a challenging task. Accurate estimations of change are confounded by many factors. Some factors are inherent in the images themselves such as scanner induced geometric distortion, intensity nonuniformities, and artifacts due to movement. Others are intrinsic to the methods used, such as the inevitable effects of partial volume induced by image realignment, biases inherent in computational algorithms and lack of definitive approaches for modeling biological change. Additionally, the veracity of all methods is difficult to determine due to limitations of current methods for simulating atropy.

A major issue in brain change quantification is whether to model change in terms of strong deformations at region boundaries that attenuate quickly with distance from the boundary, or milder deformations that are more evenly distributed throughout the adjacent region. The former may provide more sensitive and localized measurement, but requires an explicit definition of region boundaries (e.g., edges) and may misrepresent highly localized artifacts (noise) that masquerade in follow-up images as true change. Conversely, the smoothness of the latter may make it more robust to noise but less sensitive to actual subtle, localized changes. An ideal method would thus possess high sensitivity (e.g., identifying true biological change), high localization (e.g., representing change in regions conforming to where differences actually occur) and high specificity (e.g., ignoring most artifacts).

In view of the drawbacks of previously known systems, it would be desirable to provide systems and methods for combining the localization and sensitivity advantages of boundary-based approaches with the specificity of smoother region-based approaches.

### SUMMARY

The subject matter described below overcomes the drawbacks of previously-known systems by providing systems and methods for computing a longitudinal change in a structure of a brain. The method may include receiving a first image of the brain, wherein the first image is captured at a first time; receiving a second image of the brain, wherein the second image is captured at a second time; aligning the first and second images; generating at least one displacement from a location in the first image back to a corresponding location in the second image; and determining an optimized matching deformation between the first and second images based on an energy function that incorporates spatially varying estimates of a likelihood of tissue edge presence at the location in the first image. The matching deformation may be one of the generated displacements. Generating at least one displacement may include generating multiple displacements from multiple locations in the first image back to multiple corresponding locations in the second image.

In accordance with one aspect of the subject matter described below, the first and second images are aligned using an optimized linear transformation technique. The spatially varying estimates for the likelihood of tissue edge presence may be determined based on intensity gradient magnitudes. In accordance with another aspect of the subject matter, the energy function is comprised of an image-dissimilarity metric and a regularizing penalty term. In a further aspect, the image-dissimilarity metric uses a cross-correlation formula. The method may incorporate the spatially varying estimates for the likelihood of tissue edge presence into the energy function by inserting a voxel-varying weighting factor derived from estimates of tissue edge presence locations into the cross-correlation formula and into the penalty term, each insertion being inversely proportional to the other. In accordance with another aspect of the subject matter, the energy function is optimized using a fluid-flow technique to solve for a velocity field, wherein the velocity field updates the matching deformation iteratively over one or more increments of time via an Euler integration. In accordance with an additional aspect, a penalty term is used that is based on a Kullback-Liebler divergence metric for log-Jacobian distributions with the inserted term based on estimates of edge presence.

In accordance with another aspect subject matter, a system for computing a longitudinal change in a structure of a brain is provided including one or more processors configured to perform the methods described above.

In accordance with yet another aspect of the present subject matter, a non-transitory computer-readable medium having instructions stored thereon is provided, wherein the instructions are configured to perform the methods described above.

### BRIEF DESCRIPTION OF THE DRAWINGS

FIG. 1 depicts the components of an exemplary brain change quantification system constructed in accordance with the principles of an illustrative implementation.

FIG. 2 is a flow diagram of an exemplary brain change quantification method in accordance with the principles of an illustrative implementation.

FIG. 3 depicts a table summarizing respective forces for KL and G-KL.

FIG. 4 depicts an exemplary computer system constructed in accordance with the principles of an illustrative implementation.

FIG. 5 depicts a table with demographic characteristics of a validation group.

FIG. 6A depicts a synthetic image constructed to show high levels of “atrophy” in small structures at “time 2” with reference to “non-atrophy” at “time 1”.

FIG. 6B depicts the log-jacobians computed by a TBM algorithm containing voxel-varying estimates of tissue boundaries (“G-KL”) and a TBM algorithm without voxel-varying estimates of tissue boundaries (“KL”).

FIG. 6C depicts a graph illustrating a cross section of log-jacobian values for the G-KL and KL algorithms comparing the performance of the algorithms in image areas of small detail.

FIG. 7 depicts a group summarizing voxel patterns of KL and G-KL for the twelve subjects in the no-change dataset.

FIG. 8 depicts the average log-jacobian values for the G-KL and KL methods.

FIG. 9 depicts the average log-jacobian values over 20 one-year AD “change” images for the G-KL and KL methods.

FIG. 10 depicts the statROls constructed for G-KL and KL.

FIG. 11 depicts a table illustrating results of change estimate comparisons with prior results.

FIG. 12A depicts voxel level results for the AD-CN comparison.

FIG. 12B depicts voxel level results from the MCI-CN comparison.

FIG. 13 depicts a graph summarizing the results of diagnostic group analyses by method (G-KL vs. KL) showing mean log-jacobian over the sROI for each method.

FIG. 14 depicts a graph summarizing the results of mean jacobian differences at one year comparing converters to non-converters for the G-KL and KL methods.

FIG. 15 depicts voxelwise significance results for the MMSE change regression for the G-KL and KL methods.

FIG. 16 depicts voxelwise cluster significance images for the associate between baseline CSF A-β and log-jacobian for the G-KL and KL methods.

FIG. 17 depicts a table summarizing age, education, and gender adjusted associations between cognitive and CSF measures for the G-KL and KL methods.

### DETAILED DESCRIPTION

Systems and methods are provided for an inverse-consistent method of brain change detection that combines tensor-based morphometry (TBM) methods for computing spatially-smooth and specific deformation fields with edge information akin to the boundary mask concept for localizing change to region boundaries. The systems and methods may detect changes in brain structure over time due to genetic abnormalities, disease, or atrophy associated with brain degenerative diseases (e.g., Alzheimer's disease, Frontal Temporal Dementia (FTD), Fragile X syndrome, HIV/AIDS, etc). Advantageously, the systems and methods may be used to measure longitudinal brain change with enhanced sensitivity and localization while retaining specificity. Such measurements may be useful in diagnosing brain diseases and/or monitoring efficacy of treatment on a brain (e.g., comparing trends in longitudinal brain change of a group of people subjected to a treatment, such as a drug regime, versus a group of people that are subjected to a different treatment or no treatment at all) because the increased sensitivity and specificity may potentially enable statistically significant results from smaller sample sizes. For example, because a smaller sample size can be used to derive statistically significant results, a study can be conducted with fewer measurements. Thus, a company such as, but not limited to, a pharmaceutical company, can test a new product on a smaller number of subjects and still derive statistically significant test results for the product.

TBM is a commonly used and evolving technique that computes a deformation field between a pair of images and then uses the log-Jacobian determinants to map local volume change. TBM starts with vector “force fields” derived from voxel intensity mismatch functions, adds a penalty term to discourage excessive deformation, and solves for velocity “flow fields” which drive the deformation.

One drawback of TBM algorithms is that, in addition to noise sensitivity, they possess an inherent bias that overstates volume change. This problem is particularly evident when TBM methods are applied to longitudinal images with short intervals between scans, in which no actual brain atrophy should be expected. Log-jacobian images of such warps should be uniformly close to zero, yet patterns of nonzero volume “changes” typically appear at tissue boundaries and also in homogeneous brain regions. The skewness effect of the log-jacobian may be counteracted by penalizing the Kullback-Liebler divergence of the log-jacobian determinants from the identity distribution. The effect of an additive Kullback-Liebler penalty term (R_{KL}) is to smooth the jacobian fields, especially in homogeneous brain regions remote from areas of high tissue contrast. However, even in the presence of the Kullback-Liebler penalty, significant inherent bias toward indicating non-biological differences in images remains. This apparent bias may be significantly reduced by imposing inverse consistency—the simultaneous calculation of forward and backward deformations that are constrained to be inverses of one another.

Thus, penalty terms and inverse consistency are each indispensible. But in addition to reducing bias, each technique also reduces sensitivity to real change. By spreading change over larger areas, the penalty term diminishes localized sensitivity even as it enhances specificity. By reducing magnitudes, the inverse-consistency constraint also may contribute to under-reporting of real change. As a result, the TBM method may either fail to record change or attribute change too broadly throughout the image, leading to estimates that no longer reflect biological differences.

The systems and methods incorporate a notion of tissue boundary location from an established boundary-based technique into an energy functional for an inverse-consistent TBM, so that deformations near a boundary are allowed to be large while deformations away from boundaries are dampened. Force fields due to mismatch and penalty terms are each locally modified by the likelihood of edge presence. Thus, the combination of boundary terms and penalty will enhance sensitivity and localization while retaining specificity.

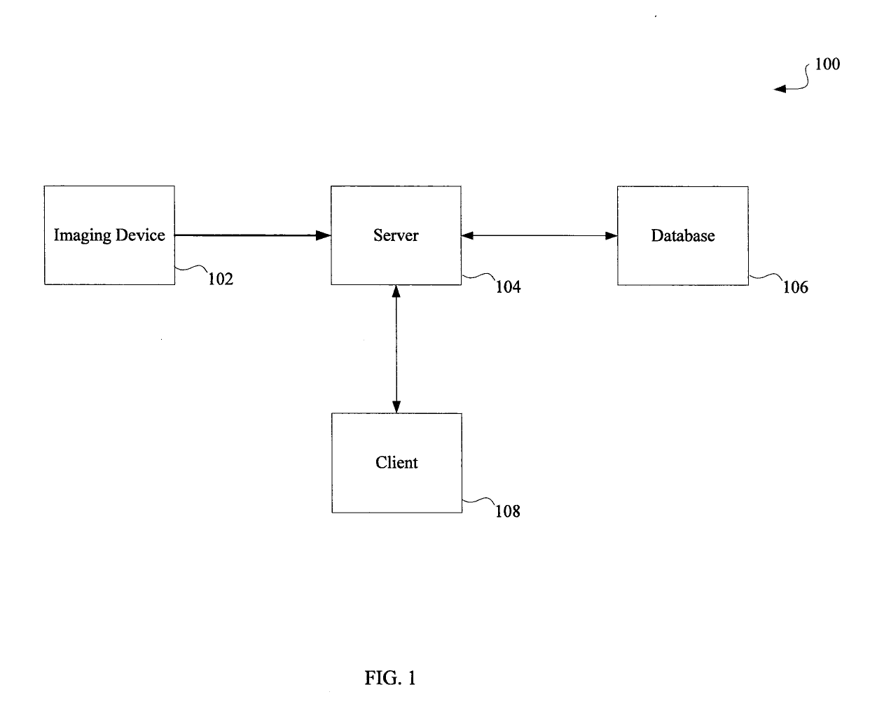

Referring now to FIG. 1, an overview of brain change quantification system 100 of an illustrative implementation is provided. In FIG. 1, components of the system are not depicted to scale on either a relative or absolute basis. Brain change quantification system 100 comprises imaging device 102, server 104, database 106, and client 108.

Imaging device 102 may be used to capture brain images at one or more periods of time. Imaging device 102 may generate medical images using imaging techniques known in the art such as, but not limited to, magnetic resonance imaging (MRI), water diffusion imaging, nerve fiber-tracking techniques such as diffusion tensor imaging or diffusion-spectrum imaging, or other suitable high quality medical imaging. Imaging device 102 may generate a first image of a patient's brain at one particular time. Imaging device 102 may be used at a later time on the same patient to generate a second image of the patient's brain at a second time. The generated images may be sent to server 104 that may process and store the generated images. Although only a single image device is depicted, one skilled in the art will understand that the first image may be generated by a first imaging device and the second image may be generated by a second imaging device.

Server 104 may receive images generated by imaging device 102. Server 104 may process the images and store the images. In one embodiment, server 104 may associate data with the generated images. For example, server 104 may associate a patient identifier, a time stamp, doctor information, etc., with the generated images. Server 104 may also store the generated images. For example, server 104 may send images to database 106 for storage. Additionally, server 104 may retrieve images from database 106 and send images to client 108. As will be understood by one skilled in the art, while server 104, database 106, and client 108 are illustratively housed separately, the components may be variously housed together. For example, server 104 and database 104 may be housed on the same computing device. In another example, server 104 may act as client 108 and provide a user interface to users of system 100.

Database 106 may be used to store image data generated by one or more imaging devices. In one embodiment, database 106 receives image data from server 104 along with additional data. The image data and the additional data may be associated together. For example, the additional data may include patient identifying information such as, but not limited, patient name, patient medical record number, address, etc. Database 106 may create, for example, a record for the patient and associate the medical images with the patient record. One skilled in the art will understand that database 106 may implement a variety of storage structures. For example, the database may be a file structure consisting of folders and files, or the database may be a relational database consisting of tables, columns, and rows.

Client 108 may be used to interface with server 104 to retrieve medical images associated with one or more patients, view images, and execute commands on images. In a preferred embodiment, a user may access patient images from client 108. The user may select images for further processing. For example, the user may select two images associated with a single patient and submit the images to determine the longitudinal brain change between the two images. Client 108 may receive copies of images (e.g., via a tangible storage device such as machine-readable medium, e.g., tape, compact disk (CD), digital versatile disk (DVD), blu-ray disk (BD), external nonvolatile memory device, USB, cloud storage, or other tangible storage medium) and process the images directly. In another example, client 108 may send a request to server 104 and server 104 may execute the commands. Thus, client 108 may be notified of results by server 104 once the requested operation has been completed by server 104.

A. Incorporating Boundary Information into TBM

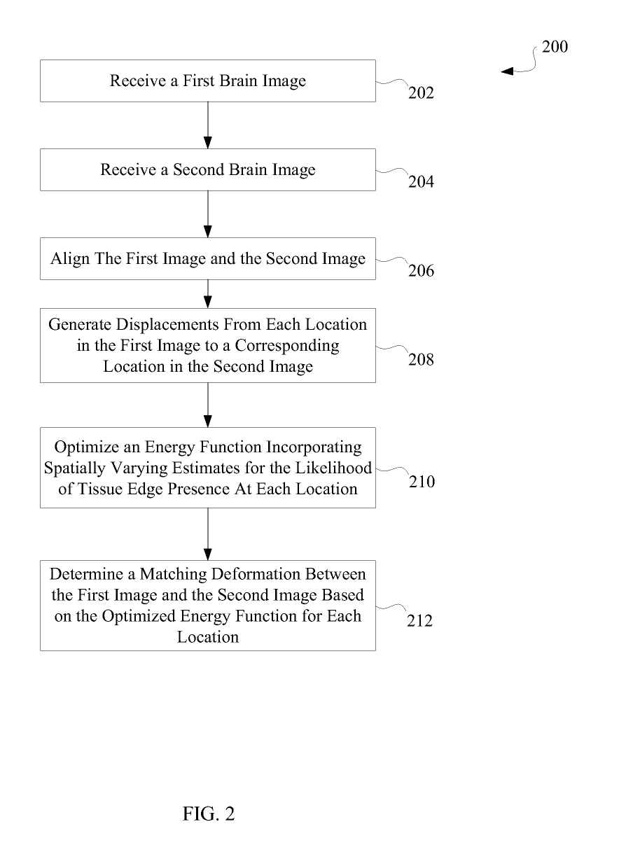

Referring now to FIG. 2, a flow diagram of an exemplary brain change quantification method 200 of an illustrative implementation is provided. Additional, fewer, or different operations may be performed, depending on the embodiment. Method 200 may be implemented on a computing device. In one implementation, method 200 is encoded on a computer readable medium that contains instructions that, when executed by a computing device, cause the computing device to perform operations of the method 200. Although the exemplary method is performed on server 104, one skilled in the art will understand that the operations of method 200 may be performed on a different computer, such as, but not limited to, client 108. Additionally, the operations of method 200 may be performed on different computers in system 100.

In a preferred embodiment, described below, method 200 uses two medical images received at server 104 to determine longitudinal brain change. For example, let Ω be a bounded 3D image space. T₁ and T₂ are real-valued intensity functions on Ω representing the first image and the second image, respectively. Server 104 may align T₁ and T₂. Server 104 may generate possible displacements for each location (e.g., locations in a brain selected by a user, server 104, and/or client 108) in T₁ to one or more locations (e.g., locations in the brain selected by a user, service 104, and/or client 108) in T₂. Server 104 may optimize an energy function incorporating spatially varying estimate for the likelihood of tissue edge (e.g., brain boundary, gray matter boundary, white matter boundary) presence at each location based on the generated displacements. Server 104 may determine a matching deformation based on the optimized energy function.

In operation 202, server 104 may receive a first image (T₁) of a bounded 3D image space (S2). In an embodiment, server 104 requests T₁ from database 106. For example, server 104 may request an image with a particular patient identifier and a particular time stamp associated with it. In another example, an image with a unique image identifier may be requested. In another embodiment, server 104 may request an image from imaging device 102. Thus, server 104 may send a request to imaging device 102 to generate an image and the generated image may be maintained by server 104 as T₁.

In operation 204, server 104 may receive a second image (T₂) of the bounded 3D image space (S2). In an embodiment, server 104 requests a T₂ from database 106. For example, server 104 may request an image for a patient with the same patient identifier as the first image but with a different timestamp. In another example, an image with a unique image identifier may be requested. In another embodiment, server 104 may request an image from imaging device 102. Thus, server 104 may send a request to imaging device 102 to generate an image and the generated image may be maintained by server 104 as a second image.

In operation 206, server 104 may align the received first and second images. In an embodiment, the images may be aligned using a transformation. For example, the images T₁ and T₂ may be aligned using an optimized linear transformation.

In operation 208, server 104 may generate displacements from each location in T₂ to a corresponding location in T₁. To compute a deformation of T₂ onto T₁, an inverse-consistent deformation g: Ω→Ω may be computed such that for each location x in Ω, T₁(g(x)) should equal T₂(x). The deformed image is therefore T₁° g. Let u(x) be the displacement from a position in the deformed image back to its source in T₂. Then g(x)=x−u(x). The generated displacements may match each location in T₂ to one or more locations in T₁. The displacements may be used to determine a matching deformation.

In operation 210, server 104 may optimize an energy function incorporating spatially varying estimates for the likelihood of tissue edge presence at each location. In an embodiment, the optimized energy function E may be used to find an optimal g or equivalently an optimal u for the deformation between the images. For example, a TBM algorithm may be modified to incorporate spatially varying estimates for the likelihood of tissue edge presence at each location. Generally, E has the format:

E(T₁,T₂,u)=M(T₁,T₂,u)+λR(u),

where M is an image dissimilarity term and R is a regularizing penalty term, both dependent on the deformation u. A common image dissimilarity metric is mutual information (MI) although least squares may be used. For example, cross-correlation (CC) may be used. It is maximized when the image intensity arrays lie along a regression line and this is appropriate for registering images of the same MRI modality.

A modified TBM algorithm may include a change detection method with boundary detection (G-KL) that inserts a voxel-varying weighting factor based on probabilistic estimates of boundary locations into the CC formula, creating a new dissimilarity functional (G-CC). For a TBM method having no boundary information (KL), the penalty term may be R_{KL} and for G-KL, the modified penalty term may be G-R_{KL}, which also makes use of the boundary estimates. The modified penalty term is described below. The parameter λ governs the strength of the penalty term.

The algorithm solves the Euler-Lagrange equation ∂ᵤE=0, at least approximately, obtaining a u to optimize E. The variational derivative of the matching term M takes the form:

∂ᵤM=m(T₁,T₂,u)∇T₁(g(x)),

where m is a scalar function and ∇T₁(g(x)) is the intensity gradient of T₁ at the location specified by g(x) (in our implementation T₁ is the target image). The variational derivative of M has an inherent asymmetry because it depends explicitly only on the gradients of T₁. As described below, introducing terms derived from the gradient of T₂ may partially balance this asymmetry. Additionally, inverse consistency restores symmetry in the sense that it solves for deformations in both directions, with each the inverse of the other; the “backward direction” deformation depends on ∇T₂.

The combined variational derivative of E is a force field ∂ᵤE=F₁+λF₂, with F₁ and F₂ being the variational derivatives of the matching term and penalty term, respectively. F₁ is a force generated by intensity mismatch of the two images at each voxel, driving the solution toward image matching. F₂ is a force driving the solution to reduce the penalty term.

1) The Fluid Flow Method:

Instead of solving the Euler-Lagrange equation by gradient descent, fluid flow methods solve for the flow velocity field v, then use it to update the deformation u iteratively over small time interval increments via Euler integration:

u(x,t+Δt)=u(x,t)+(v−v·∇u)Δt.

This formula is based on a discrete approximation to the total time derivative of u. The size of the time increment Δt is often varied so that a maximal u displacement is not exceeded at each iteration

The velocity v is derived by using successive over-relaxation (SOR) to solve the Navier-Stokes partial differential equation:

μ∇²v+(μ+v)∇(∇·v)=−F(x,u).

In sum, the fluid flow method consists of iterated steps, each step generating v from the current force field, updating u and checking to see whether a termination condition is satisfied.

2) The Kullback-Liebler Penalty Term:

A fluid-flow implementation may be used in which the matching term is MI, the velocity v is computed by Gaussian convolution, and the penalty term R_{KL} is based on the Kullback-Liebler divergence metric for the log-jacobian distributions. R_{KL} is a measure of the divergence between probability densities P_{id} and P_{g}, the identity distribution and log-Jacobian distribution for g, respectively. Since R_{KL} penalizes deviation from a uniform distribution, it tends to homogenize the Jacobian field in the absence of strong mismatch forces. R_{KL} is expressed as:

R_{KL}=∫_{Ω}log|Dg(x)|dx

Thus the total energy functional has the form:

E(T₁,T₂,u)=M(T₁,T₂,u)+λR_{KL}(u).

3) Fluid Flow Incorporating Boundary Information:

G-KL is the same as KL except that its energy functional incorporates spatially varying a priori estimates for the likelihood of tissue edge presence at each location x, based on intensity gradient magnitudes. Because T₂ does not move while T₁ is iteratively pulled toward it by g, T₂ may be used to generate these estimates. To assess edge likelihood, a probabilistic map of edge locations in T₂ may be created from the cumulative distribution function (CDF) of slightly smoothed T₂ intensity gradient magnitudes. The function GradCDF(x) is defined as the percentile of the gradient magnitude of T₂ at location x in this CDF. High values, close to 1, occur at locations of strong gradients and almost always at edges. The GradCDF image appears very similar to an intensity gradient magnitude image, but the values between 0 and 1 indicate probabilities of edge proximity rather than the actual magnitude of the intensity gradient.

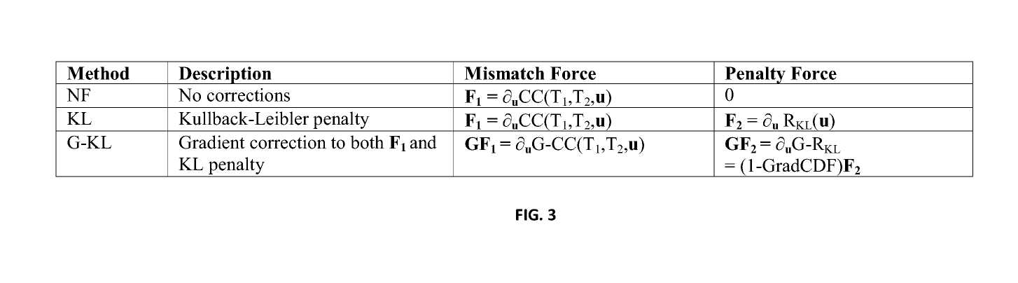

The respective forces for KL and G-KL are defined here and summarized in FIG. 3 Define:

F₁=∂ᵤCC(T₁,T₂,u),

F₂=∂ᵤR_{KL}(u),

to be the mismatch and penalty forces in the KL implementation.

To derive corresponding forces fields for G-KL, energy functionals G-CC and G-R_{KL} may be defined to contain the GradCDF multipliers at appropriate positions as voxel-based weighting terms. Then, the corresponding forces will be:

GF₁=∂ᵤG-CC(T₁,T₂,u),

GF₂=∂ᵤG-R_{KL}(u),

a) Derivation of Mismatch Forces for KL and G-KL:

For simplicity of computation the means of T₁ and T₂ may be set internally to zero before starting the solution. Since the working version of T₁ changes as it is iteratively pulled toward T₂, its mean intensity also changes at each iteration, but in practice these deviations from zero are small (on the order of 1% of the maximum intensity at most) and are ignored. Then, the formulas for CC and G-CC may be expressed as follows.

Define:

v₁₂=∫_{Ω}T₁(g(x))T₂(x)dx (covariance of T₁ and T₂ intensities)

v₁=∫_{Ω}T₁²(g(x))dx (variance of T₁)

v₂=∫_{Ω}T₂²(x)dx (variance of T₂)

Then

CC=v₁₂²/(v₁v₂).

Using the rules for variational derivatives, which may parallel the usual quotient, produce and chain rules,

$$\begin{matrix}{\partial }_{u} CC = ( 2 {v}_{1} {v}_{2} {v}_{12} {\partial }_{u} {v}_{12} - {v}_{12}^{2} {v}_{2} {\partial }_{u} {v}_{1} ) / {( {v}_{1} {v}_{2} )}^{2} \\ = 2 ( {T}_{2} ( x ) {v}_{1} {v}_{2} {v}_{12} - {T}_{1} ( g ( x ) ) {v}_{12}^{2} {v}_{2} ) / {( {v}_{1} {v}_{2} )}^{2} ∇ {T}_{1} ( g ( x ) ) .\end{matrix} \qquad ( 1 )$$

This gives the mismatch force for KL. Now define G-CC as follows, using similar notation as for CC but with modified formulas.

gv₁₂=∫_{Ω}GradCDF(x)T₁(g(x))T₂(x)dx (weighted covariance of T₁ and T₂).

gv₁=∫_{Ω}GradCDF(x)T₁²(g(x))dx (weighted variance of T₁)

gv₂=∫_{Ω}T₂²(x)dx (variance of T₂)

Then

G-CC=gv₁₂²/(gv₁gv₂). (2)

Since GradCDF(x) is derived solely from T₂ and is therefore constant with respect to g, the variational derivatives become

$${\partial }_{u} G - CC = ( 2 {gv}_{1} {gv}_{2} {gv}_{12} {\partial }_{u} {gv}_{12} - {gv}_{12}^{2} {gv}_{2} {\partial }_{u} {gv}_{1} ) / {( {gv}_{1} {gv}_{2} )}^{2} = 2 GradCDF ( x ) ( {T}_{2} ( x ) {gv}_{1} {gv}_{2} {gv}_{12} - {T}_{1} ( g ( x ) ) {gv}_{12}^{2} {gv}_{2} ) / {( {gv}_{1} {gv}_{2} )}^{2} ∇ {T}_{1} ( g ( x ) ) .$$

Thus formally ∂ᵤG-CC resembles “GradCDF(x) times ∂ᵤCC” but the correspondence is not exact because the constants gv₁₂ and gv₁ are not equal to their counterparts v₁₂ and v₁. Nonetheless, the resemblance is instructive because it shows that the mismatch force magnitudes are explicitly modulated by GradCDF.

b) Derivation of Penalty Forces:

The derivation of the penalty forces for G-R_{KL} is simpler. Define,

G-R_{KL}=∫_{Ω}(1−GradCDF(x))log|Dg(x)|dx.

Then as with the mismatch forces, since GradCDF is independent of g,

$$\begin{matrix}{\partial }_{u} G - {R}_{KL} = ( 1 - GradCDF ( x ) ) {\partial }_{u} {\int }_{Ω} log \vert Dg ( x ) \vert d x \\ = ( 1 - GradCDF ( x ) ) {\partial }_{u} {R}_{KL} ( u ) ,\end{matrix}$$

in other words,

GF₂=(1−GradCDF(x))F₂,

where, as above, F₂ is the penalty force vector field for KL.

In G-KL the multiplier functions GradCDF and 1−GradCDF guide the warp using anatomical knowledge of T₂, based on the following considerations. Mismatch forces F₁ occurring at or near tissue boundaries are more likely to represent real biological change and should be preserved. On the other hand, F₁ forces at a distance from edges are more probably due to noise and should be attenuated. The formula of GF₁ at each voxel accomplishes both these aims since GradCDF will be close to 1.0 near edges and lower away from them. Likewise, the penalty force should be dampened near edges while allowing its full effect away from them, and this may be accomplished by (1−gradCDF)F₂.

G-KL partially redresses the asymmetry of the original Euler-Lagrange equation resulting from the presence of only T₁ gradients. Gradient-derived information from both of the images, e.g., ∇T₁(g(x)) from T₁ and GradCDF(x) from T₂, is now present in G-KL, although they are not in the same form. Rather than being an actual gradient, GradCDF is a scalar multiplier related to the boundary mask concept in the known art.

4) Inverse Consistency:

Inverse-consistency may be implemented based on deformations in the forward and backward directions. Let g and h be deformations in the forward and backward directions, respectively, with corresponding displacement fields u and w.

The energy functional to be optimized is:

$$\begin{matrix}E ( {T}_{1} , {T}_{2} ) = {E}_{F} ( {T}_{1} , {T}_{2} , u ) + {E}_{B} ( {T}_{2} , {T}_{1} , w ) \\ = {M}_{F} ( {T}_{1} , {T}_{2} , u ) + λ R ( u ) + {M}_{B} ( {T}_{2} , {T}_{1} , w ) + λ R ( w )\end{matrix}$$

The subscripts “F” and “B” refer to the forward and backward directions. In this setting M_{F} and M_{B} are formally the same but the roles of T₁ and T₂ are opposite, and M_{F} depends on u while M_{B} depends on w.

The algorithm calculates g and h concurrently, imposing the constraint that at each iteration the composition of the current g and h, incorporating the updates being computed at this iteration, must to second order equal the identity function.

The derivatives ∂ᵤE and ∂_{W}E are each a sum of two variational terms because of the summation of E_{F} and E_{B}. Updates to the forward deformation g come from solutions to the Navier-Stokes equation (4) for ∂ᵤE=∂ᵤE_{F}+∂ᵤE_{B}, while updates to h come from solutions for ∂_{w}E. It is straightforward to compute ∂ᵤE_{F} and ∂_{W}E_{B}, as described above in (1) or (2), but the dependences of E_{F} and E_{B} on their “opposite” deformations are not explicitly known, so the derivatives ∂_{w}E_{F} and ∂ᵤE_{B} are inferred by imposing the identity constraint mentioned above.

The result of this constraint is a pair of linear equations involving the jacobians Dg and Dg⁻¹, by which we solve for ∂_{w}E_{F} and ∂ᵤE_{B} in terms of the already computed ∂ᵤE_{F} and ∂_{W}E_{B}. This avoids the necessity of actually inverting g and provides the updates for both g and h at the current iteration.

For inverse-consistent versions of the two methods, M_{F}=M_{B}=CC and R=R_{KL} for KL, with M_{F}=M_{B}=G-CC and R=G-R_{KL} for G-KL may be used.

In an operation 212, the server 202 can determine the matching deformation between T₁ and T₂. A matching deformation between T₁ and T₂ means finding an optimal g or equivalently an optimal u for the deformation between the images. In an embodiment, the matching deformation may be the deformation that leads to the most optimized E in operation 210. For example, the E calculated for each u can be compared and the lowest value of the energy function (E) can be considered the optimized energy function. Thus, the deformation the optimized energy function may be determined to be the matching deformation.

The above embodiment describes the incorporation of boundary factors to derive mismatch and penalty forces in one specific implementation. The same boundary factors, or other similarly derived information, may be incorporated into additional implementations.

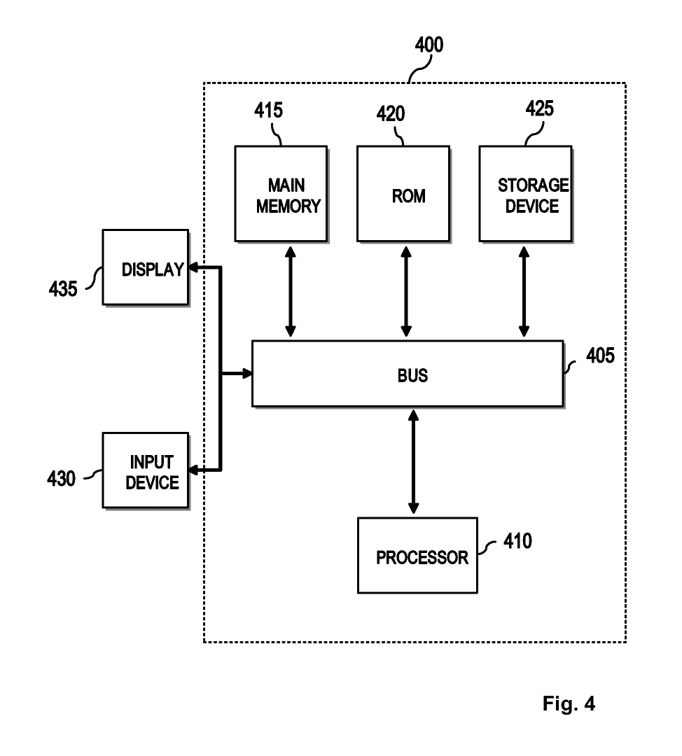

Referring now to FIG. 4, a block diagram of an illustrative computer system is depicted. The computer system or computing device 400 may be used to implement cell phones, clients, servers, cloud computing resources, etc. Computing system 400 includes bus 405 or other communication component for communicating information and processor 410 or processing circuit coupled to bus 405 for processing information. Computing system 400 may also include one or more processors 410 or processing circuits coupled to the bus for processing information. Computing system 400 also includes main memory 415, such as a random access memory (RAM) or other dynamic storage device, coupled to bus 405 for storing information, and instructions to be executed by processor 410. Main memory 415 may also be used for storing position information, temporary variables, or other intermediate information during execution of instructions by processor 410. Computing system 400 may further include read only memory (ROM) 420 or other static storage device coupled to bus 405 for storing static information and instructions for processor 410. Storage device 425, such as a solid state device, magnetic disk or optical disk, is coupled to bus 405 for persistently storing information and instructions.

Computing system 400 may be coupled via bus 405 to display 435. Input device 430, such as a keyboard, may be coupled to bus 405 for communicating information and command selections to processor 410. In another implementation, input device 430 has a touch screen display 435. Input device 430 may include a cursor control, such as a mouse, a trackball, or cursor direction keys, for communicating direction information and command selections to processor 410 and for controlling cursor movement on display 435.

According to various implementations, the processes described herein may be implemented by computing system 400 in response to processor 410 executing an arrangement of instructions contained in main memory 415. Such instructions may be read into main memory 415 from another computer-readable medium, such as storage device 425. Execution of the arrangement of instructions contained in main memory 415 causes computing system 400 to perform the illustrative processes described herein. One or more processors in a multi-processing arrangement may also be employed to execute the instructions contained in main memory 415.

It should be noted that although the discussions herein may refer to a specific order and composition of method steps, it is understood that the order of these steps may differ from what is described. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present invention. Such variations will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps.

Unless otherwise defined, all technical and scientific terms used herein have the same meaning as commonly understood by one of ordinary skill in the art to which this invention belongs.

The inventions illustratively described herein may suitably be practiced in the absence of any element or elements, limitation or limitations, not specifically disclosed herein. Thus, for example, the terms “comprising”, “including,” containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed.

Thus, it should be understood that although the present invention has been specifically disclosed by preferred embodiments and optional features, modification, improvement and variation of the inventions embodied therein herein disclosed may be resorted to by those skilled in the art, and that such modifications, improvements and variations are considered to be within the scope of this invention. The materials, methods, and examples provided here are representative of preferred embodiments, are exemplary, and are not intended as limitations on the scope of the invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

In addition, where features or aspects of the invention are described in terms of Markush groups, those skilled in the art will recognize that the invention is also thereby described in terms of any individual member or subgroup of members of the Markush group.

All publications, patent applications, patents, and other references mentioned herein are expressly incorporated by reference in their entirety, to the same extent as if each were incorporated by reference individually. In case of conflict, the present specification, including definitions, will control.

It is to be understood that while the disclosure has been described in conjunction with the above embodiments, that the foregoing description and examples are intended to illustrate and not limit the scope of the disclosure. Other aspects, advantages and modifications within the scope of the disclosure will be apparent to those skilled in the art to which the disclosure pertains.

### EXAMPLES

The present compositions and methods will be understood more readily by reference to the following examples, which are provided by way of illustration and are not intended to be limiting in any way.

Longitudinal Image Data

Data used in the preparation of the below examples were obtained from the Alzheimer's Disease Neuroimaging Initiative (ADNI) database (www.loni.ucla.edu/ADNI). The ADNI was launched in 2003 by the National Institute on Aging (NIA), the National Institute of Biomedical Imaging and Bioengineering (NIBIB), the Food and Drug Administration (FDA), private pharmaceutical companies and non-profit organizations, as a $60 million, 5-year public-private partnership. The primary goal of ADNI has been to test whether serial magnetic resonance imaging (MRI), positron emission tomography (PET), other biological markers, and clinical and neuropsychological assessment may be combined to measure the progression of mild cognitive impairment (MCI) and early Alzheimer's disease (AD). Determination of sensitive and specific markers of very early AD progression is intended to aid researchers and clinicians to develop new treatments and monitor their effectiveness, as well as lessen the time and cost of clinical trials. ADNI is the result of efforts of many co-investigators from a broad range of academic institutions and private corporations, and subjects have been recruited from over 50 sites across the U.S. and Canada. The initial goal of ADNI was to recruit 800 adults, ages 55 to 90, to participate in the research—approximately 200 cognitively normal older individuals to be followed for 3 years, 400 people with MCI to be followed for 3 years, and 200 people with early AD to be followed for 2 years.

Each of the above described TBM algorithms (i.e., the KL algorithm which does not incorporate voxel-varying boundary estimate terms and the G-KL algorithm which incorporates voxel-varying boundary estimate terms) were tested in several warping experiments. All ADNI images were subjected to a correction protocol described in the known art. This included 1) the GradWarp correction procedure for gradient nonlinearity, 2) a “B1-correction” adjusting for intensity inhomogeneities due to B1 nonuniformities, 3) “N3” bias field correction, and 4) geometric scale adjustment using a phantom scan acquired with each image.

Two sets of data were used in the examples below. The first includes a developmental data set with a “no-change” group of 12 subjects having two scans made on the same day, and a second “change” group of 20 subjects diagnosed with Alzheimer's disease having scans approximately one year apart. The developmental dataset tested the above described systems and methods to determine if G-KL reduces noise and bias almost as much as KL for images in which no biological change is expected.

The second group was a validation dataset. It consisted of a larger number of subjects having repeated imaging separated by 1 year with varied degrees of cognitive ability at baseline. This dataset included 106 normal (CN), 65 AD and 93 mild cognitive impairment (MCI) subjects. The subjects of the validation dataset did not overlap with any of the AD subjects in the developmental data set. Among the validation dataset, CSF measures of beta-amyloid were available for four CN, 48 AD and 93 MCI, and these were used to test voxelwise correlations of log-jacobians with levels of beta-amyloid. Finally, a subset of 50 AD, 38 MCI and 37 Normals were also used to measure cumulative longitudinal changes over time intervals of six, 12 and 24 months.

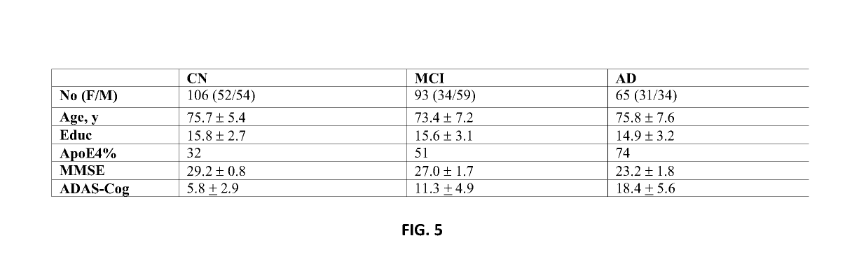

Referring to FIG. 5, demographic characteristics of the change group and the validation group, discussed above, are depicted in the table.

1) Group Comparisons:

All group analyses were based upon log-Jacobian images of the deformations. Group analyses required a deformation of all subjects onto a “minimal deformation template” (MDT) constructed to be minimally distant from images in the group. An MDT made from 29 clinically normal individuals 60 years of age or older was used. Each subject T₂ image (on which the Jacobian change maps were computed) was warped to the MDT using a cubic B-spline warp. Such a warp is standard procedure in cross-sectional image registration, where a more powerful large-deformation warp like fluid-flow would inappropriately crush together structures in regions of topological mismatch with the template. The native Jacobian determinant change maps were then deformed into MDT space to facilitate group analysis.

2) Comparison of Methods on No-Change Images:

In order to compare the performance of KL and G-KL on the dataset of no-change images, distributions of log-jacobian values between KL, G-KL, and an inverse-consistent TBM algorithm without penalty term (called NF for “no filter”) were compared.

3) Significance Testing of Voxel Log-Jacobian Values:

To assess locations of significant change in the log-Jacobian images in template space, permutation testing for correction of multiple comparisons was performed. There were several contexts in which this technique was used. Permutation testing was used on the log-Jacobian values to compute significant change within a group, to find group-difference t-values for the log-Jacobians in order to compute areas of significant differences between diagnostic groups, and finally to test for significant regression associations between log-jacobians and metadata such as MMSE or CSF amyloid-beta. Permutation testing was used for voxelwise significance of jacobian values as well as size significance for contiguous clusters of jacobian values above or below a pre-assigned threshold. In all of the examples 10,000 permutations were performed.

4) Statistical ROIs and Power Analysis:

The examples below use statistically defined ROIs as another measure of statistical power. The statistically defined ROI (statROI) is intended to focus measurements to a brain region most strongly associated with change in a given method, and therefore statROIs differ for each method. The statROI for each method was defined using voxelwise t-values for the log-jacobians,

t(x)=√nμ_{logJ}(x)/σ_{logJ}(x),

where μ_{logJ}(x) and σ_{logJ}(x) are the mean and variance, respectively, over all subject log-jacobian values at x.

The statROI for a given method consisted of voxels in brain tissue for which the voxelwise t-probability over the 20 “change” images was p 0.001 (uncorrected).

5) Correlation of Change with Cognitive or Clinical Data:

Voxel level and statistical ROI correlations were examined with clinical data as a heuristic assessment of the biological relevance for our method. Voxel-based regressions of log-Jacobians were performed with cognitive data (MMSE one-year change) and clinical biomarkers (CSF beta-amyloid). At each voxel a regression model involving the log-Jacobian values for subjects in a group and their corresponding clinical data was set up. The significance of the associations using permutation was measured using tests as described above. In addition, associations for the mean jacobian of each method statROI were analyzed on a variety of clinical tests including longitudinal differences in cognitive performance.

6) Diagnostic Group Difference Testing:

A final statistical test measured the ability of log-Jacobians to distinguish clinical diagnostic groups. For a given method the t-value of log-Jacobian difference was computed at each voxel for two clinical groups (for example AD minus CN). The null hypothesis of no difference was evaluated using permutation tests by randomly varying the assignments to the two groups. The ability of each method to detect group differences was assessed using average jacobians from their respective statROIs. Differences in the methods were further assessed by their ability to discriminate MCI subjects who converted to dementia from non-converters.

### Example 1

### Comparing Log-Jacobians Between Traditional TBM and TBM with Boundary Information

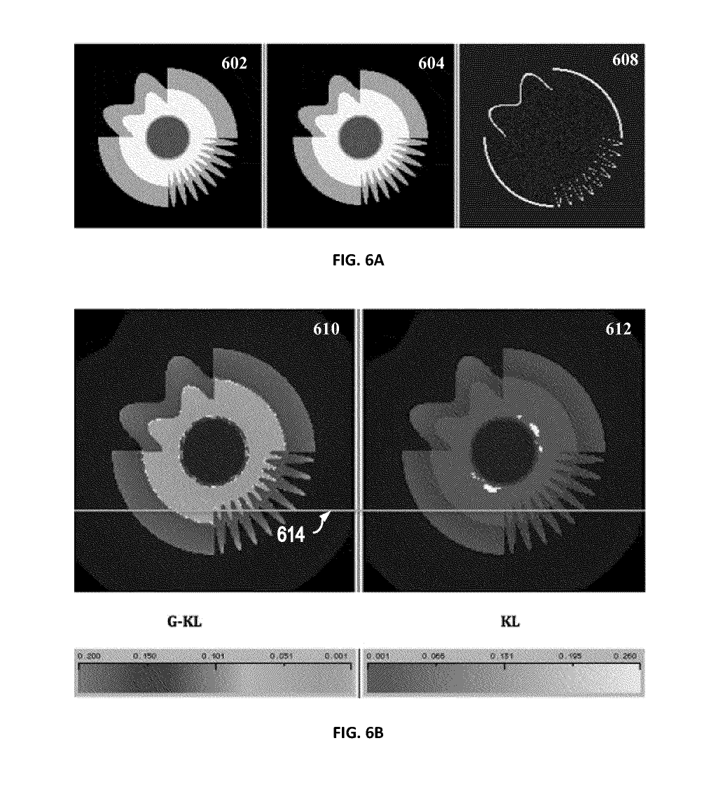

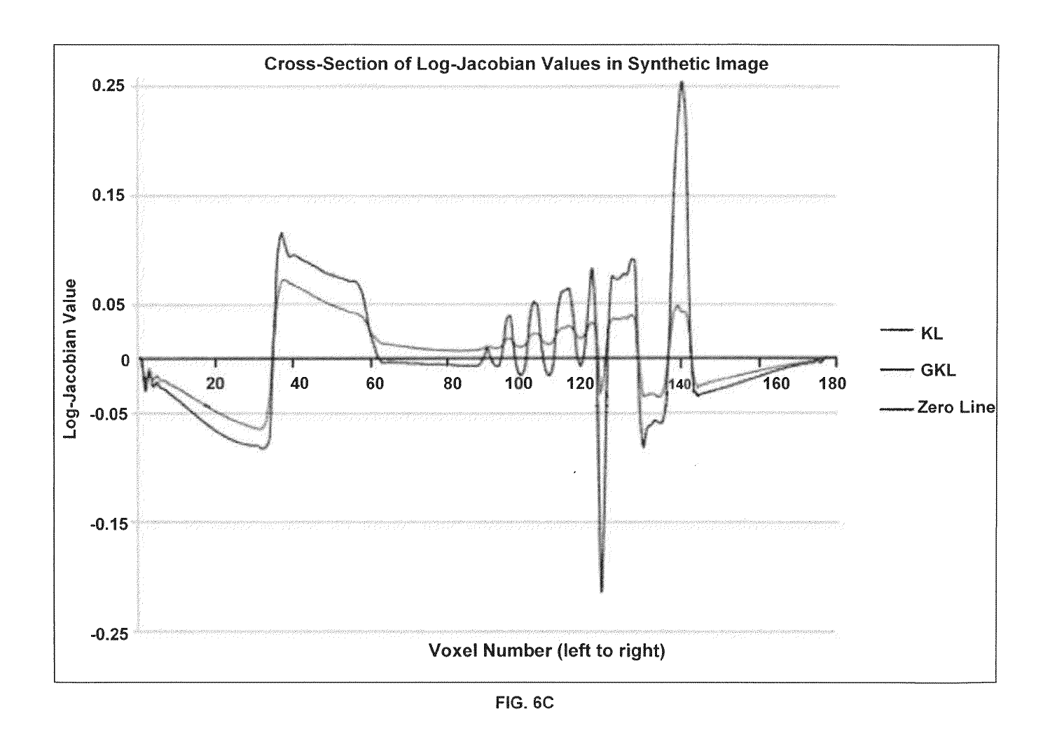

Referring to FIG. 6A, a synthetic image is constructed to show high levels of “atrophy” in small structures. Panels 602 and 604 show a synthectic “longitudinal” image pair in which the second “time point” has cortical atrophy of about 3%. Panel 608 shows the “atrophy.”

Referring to FIG. 6B, the log-jacobians computed by a TBM algorithm with KL and incorporating the R_{KL} penalty term 612 is compared to the log jacobians computed by a TBM algorithm with G-KL in which both mismatch and penalty terms incorporate prior edge estimate for the second “time point”. The GK-L image 610 uses a smoothing term and terms designed to enhance the detection of change at tissue edges. The edge-based approach has a theoretical precursor in the BBSI method which quantified brain tissue loss from the changes in rain-CSF edges. Both smoothness and sensitivity may be improved by incorporating features that promote each of these qualities, thereby allowing them to interact locally either through attenuation or promotion of forces as appropriate.

Referring to FIG. 6C, a graph illustrates a cross section of log-jacobian values along the horizontal lined indicated 614, in FIG. 6B. Intensities for G-KL and KL are shown. The graphs illustrate the increased boundary discrimination and increased sensitivity to change over small structures and also demonstrates that sensitivity may be maintained with the above described systems and methods. Therefore, the above described methods may record localized real change while retaining reasonable robustness against noise and algorithm bias.

### Example 2

### Comparison of Methods in the No-Change Images

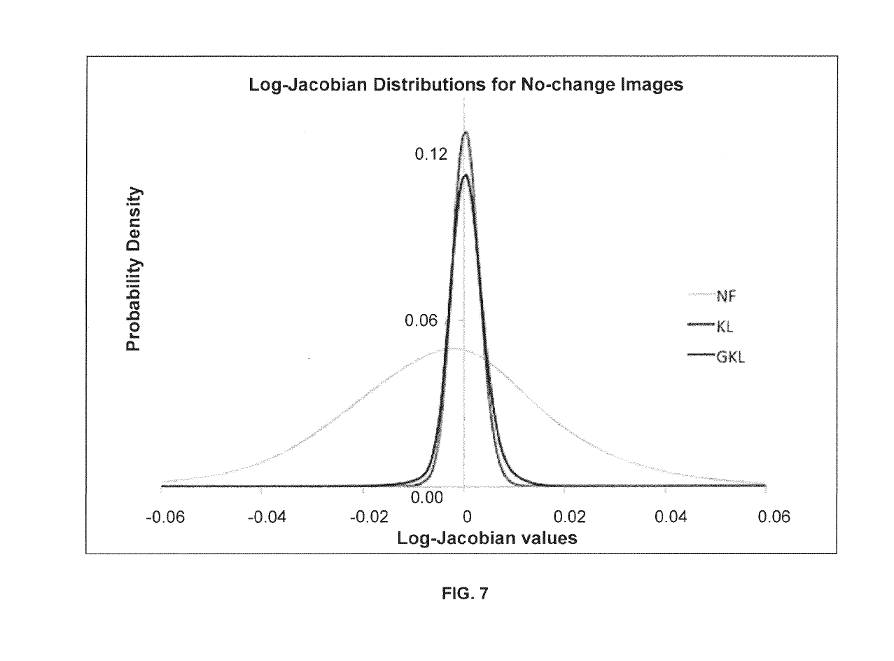

FIG. 7 summarizes voxel patterns of KL and G-KL for the twelve subjects in the no-change dataset. FIG. 7 shows histograms of log-jacobian values over the average jacobian images for KL, G-KL and also, for comparison, fluid flow having no penalty correction. The histograms of KL and G-KL are similar, though G-KL has a slightly wider distribution. Both are considerably narrower than the histogram of the uncorrected TBM, suggesting that G-KL achieves almost as much noise reduction as KL on this dataset.

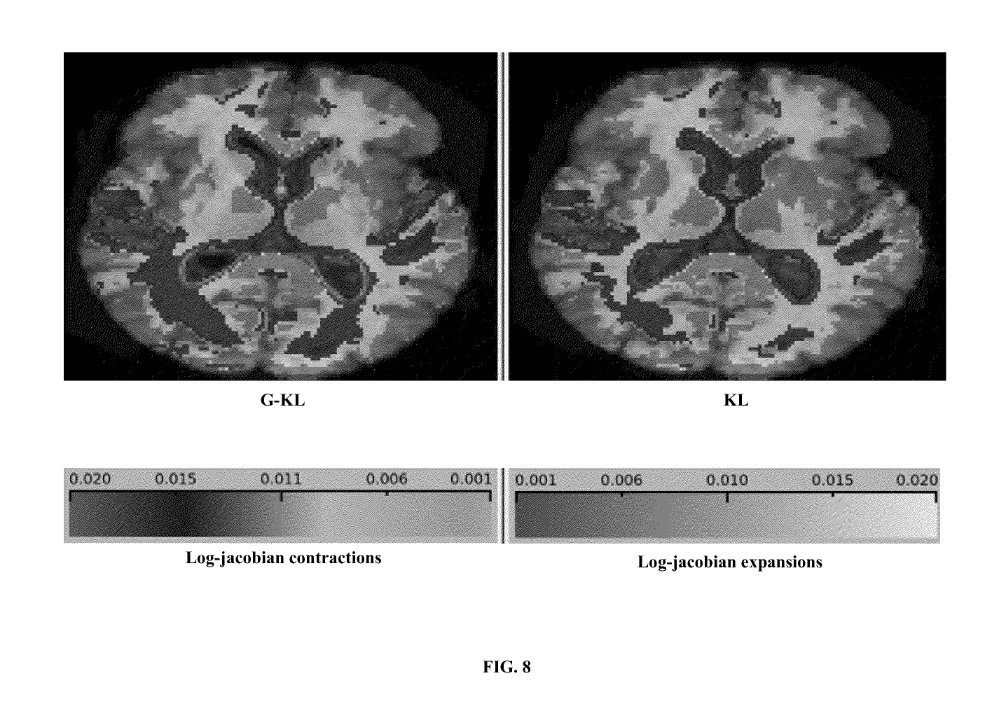

Referring now to FIG. 8, the average log-jacobian values for the G-KL and KL methods are depicted in cool colors for contractions and warm colors for expansions. There were no voxels of significant difference (corrected) between the methods.

### Example 3

### Comparison of Methods in the One-Year Change Images

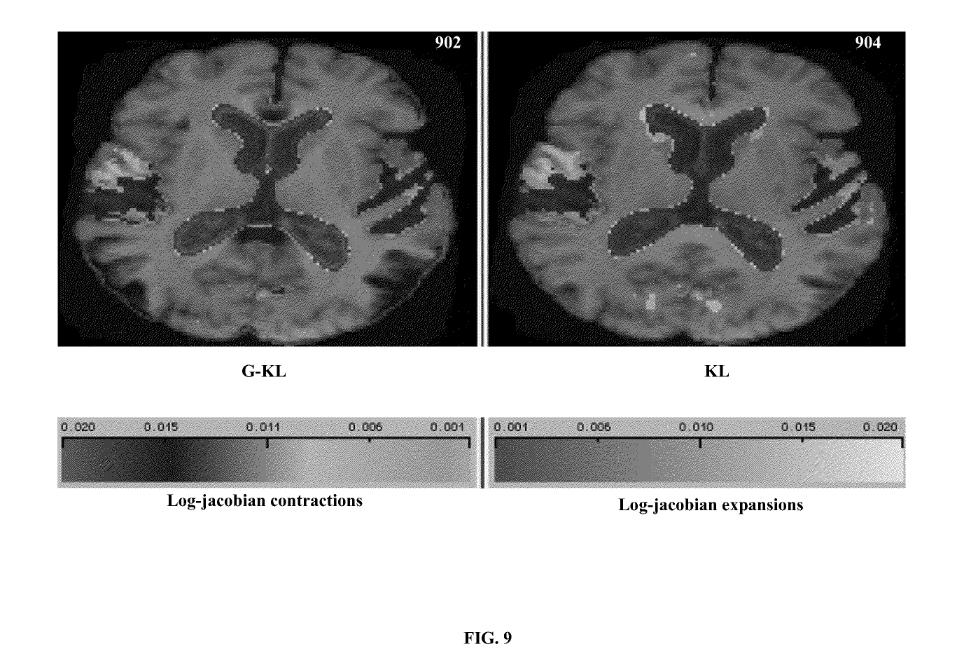

Referring now to FIG. 9, the average log-jacobian values over 20 one-year AD “change” images are depicted. The G-KL 902 and KL 904 methods both show extensive subcortical loss throughout the brain, but G-KL 902 is more sensitive to localized change visible in the splenium, cingulated, and temporal-parietal lobes.

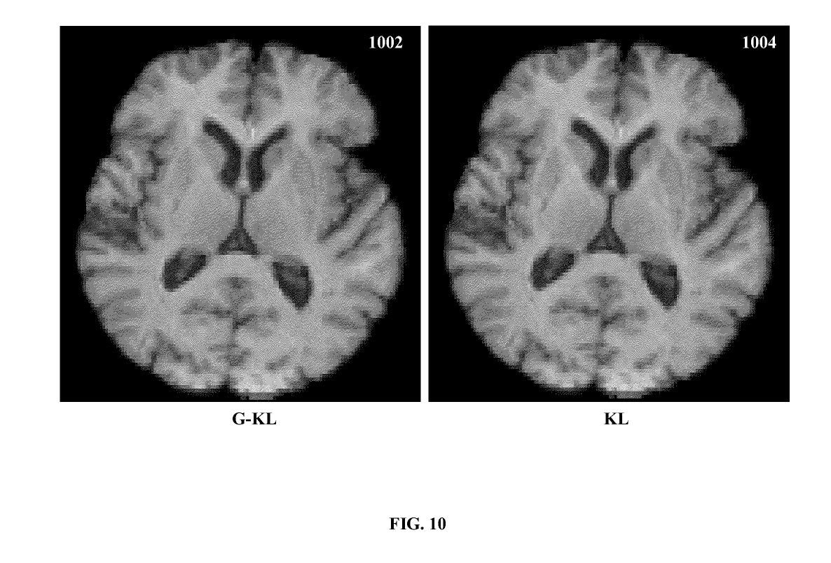

Referring to FIG. 10, the statROIs constructed as described previously for G-KL and KL are depicted. These ROIs differ mainly with G-KL 1002 showing more extensive areas of significant change in the striatum and subcortical nuclei. The results of this section suggest that G-KL 1002 has increased sensitivity to localized changes while losing only a small amount of specificity, mainly inside and at the edges of the ventricles in the no-change images.

### Example 4

### Comparison of Change Estimates with Prior Results

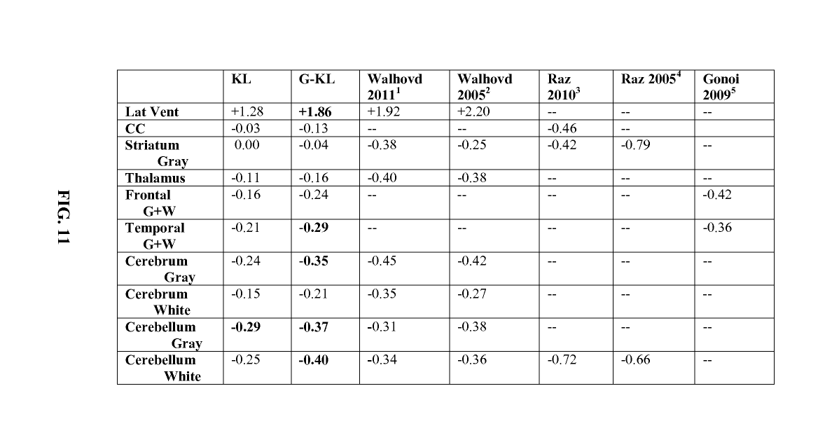

Referring to FIG. 11, a table is depicted illustrating results of change estimate comparisons with prior requests. Volumetric change factors were computed for KL and G-KL over a set of brain ROIs representing anatomical structures for which previous longitudinal change values are available. The goal was to evaluate whether KL and G-KL appear to compute “reasonable” levels of change by reference to what has already been reported.

Selected ROIs in template space included cerebral gray and white masks, corpus callosum, thalamus, striatum (gray tissue) consisting of caudate, putamen and globus pallidus, lateral ventricles, frontal and temporal lobar regions and cerebellum gray and white masks. For each ROI, the average change over the 106 normal subjects in the validation group was obtained.

The percentage changes appear in the leftmost columns of FIG. 11. Comparable data from other studies was gathered. Two studies examined changes in healthy normal subjects using hand-drawn ROIs on native subjects to measure volumes at different times. Three others also used normal subjects but the ROIs were generated by automatic labeling techniques: the first from the Center for Morphometric Analysis, the second by atlas-based template matching, and the third using FreeSurfer (http://surfer.nmr.mgh.harvard.edu). Details of the time intervals and number of subjects for these studies are given in the caption of FIG. 11.

The results show that the volume change percentages for GKL are consistently larger than those of KL and also appear to be in the same range as many of those from the automatic labeling studies. For lateral ventricles the G-KL value is within 10% of earlier studies. In cerebral and cerebellar gray and white, G-KL is within 10% of the corresponding values in an earlier study. KL is within 10% of cerebellar gray measured by known techniques. Frontal and temporal lobar values are larger in G-KL than in KL. The G-KL temporal volume change is within 20% of that in the atlas-based study.

In summary, the results of FIG. 11 indicate that both methods tend to under-report changes in subcortical brain structures compared to previous automated or hand-traced measurements, but that G-KL shows a reasonable or good match with previous results for ventricles, temporal lobes and cerebral and cerebellar gray and white tissue changes. G-KL shows change within 20% of a previous value for five regions, while KL has one (boldface in columns 2 and 3).

### Example 5

### Clinical Group Differences in the Validation Dataset

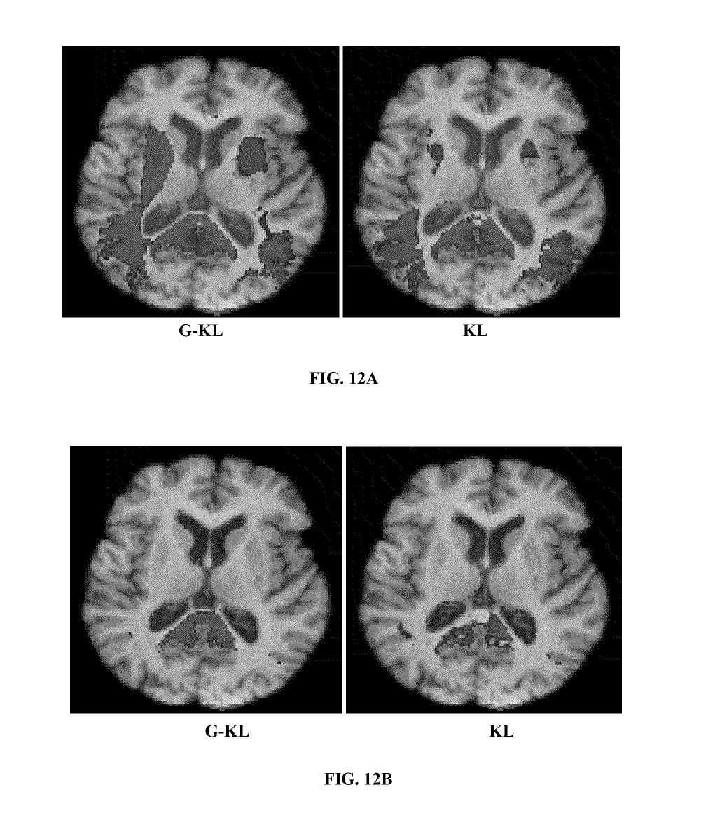

Referring to FIGS. 12A and 12B, voxel level results for AD-CN and MCI-CN comparisons are shown, respectively. The images show group difference analyses for KL and GKL. Voxel t-values for the mean log-jacobian differences between pairs of groups were generated: AD-CN, AD-MCI (not shown) and MCI-CN. The t-images were analyzed for voxelwise significance (correcting for multiple comparisons using 10,000 permutations).

FIG. 12A shows voxel level results for the AD-CN comparison and FIG. 12B shows results from the MCI-CN comparison. All colored voxels are significant to p<0.05 (corrected) for voxel t-value. No significant voxel differences were found for AD-MCI.

For the AD-CN comparison, each method shows extensive regions of greater brain tissue loss and CSF space expansion in AD. The G-KL method, however, depicts more extensive and more significant p-values in the striatal and retrosplenial areas. The G-KL also identifies significant differences in the anterior cingulate, not seen with the KL method. For the MCI-CN comparison the G-KL voxel images show greater localized splenium and retrosplenial differences.

### Example 6

### Clinical Group Differences in the sROIs

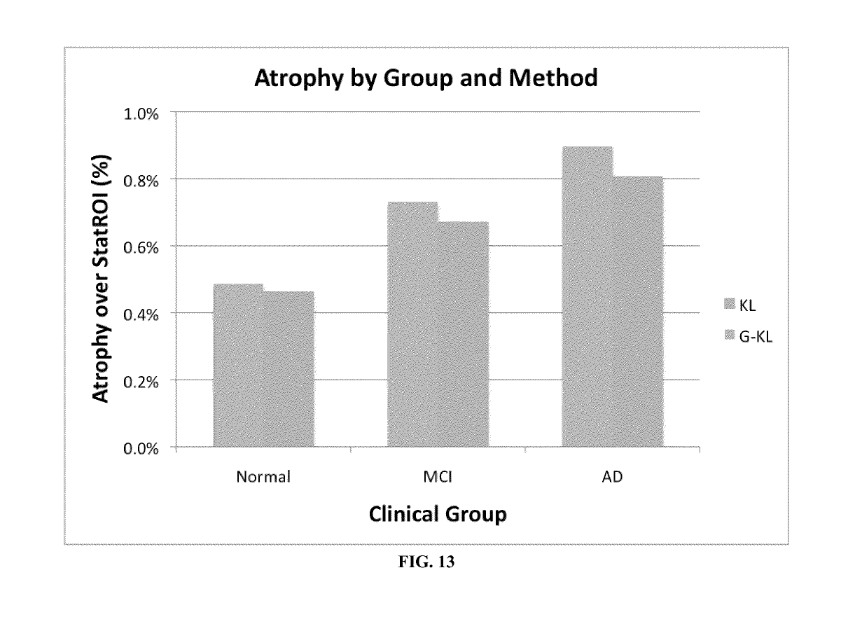

Referring to FIG. 13, a graph summarizing the results of diagnostic group analyses by method (G-KL vs. KL) showing mean log-jacobian over the sROI for each method is depicted. Using repeated measures MANOVA, there was a significant main effect of clinical group (p<0.0003) indicating significant differences in volume change according to baseline clinical diagnosis, a significant effect of method (p<0.0001) indicating that the G-KL method measured greater rates of change on average as compared to the KL method, and a significant interaction of group x method (p<0.0003) indicating that the differences in method varied by group.

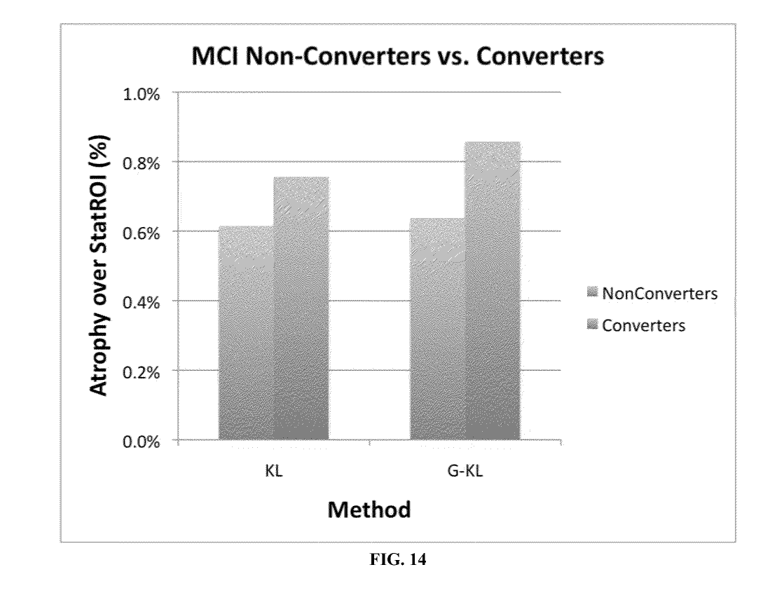

Referring now to FIG. 14, a graph summarizing the results of mean jacobian differences at one year comparing converters to non-converters for the G-KL and KL methods. Note that the greatest difference for between-group measures was found with the MCI group, favoring a larger detected difference for the G-KL method. Recognizing that MCI is a clinically heterogeneous group, further analysis was performed further analysis to assess group differences in rate of sROI change comparing those who converted to dementia to those who did not over 36 months. Of the 92 MCI subjects included in this study, 44 (46%) converted to dementia over the 36 month period of the ADNI study with an average time of conversion of 19.8 months. Using repeated measures MANOVA, there was a significant main effect of conversion status (p<0.01), a significant effect of method (p<0.0001) and a significant interaction of group x method (p<0.006) indicating that converters had significantly greater jacobian differences with the G-KL method but not with KL.

In sum, for log-jacobians of each method over its sROI, GKL significantly distinguished between MCI converters and non-converters, whereas KL did not.

### Example 7

### Regressions of Log-Jacobians vs. Clinical Data

Two sets of regressions studies were conducted for each TBM method. One regression model included MMSE one-year change as the outcome variable with voxelwise log-Jacobian as the predictor

A) MMSE One-Year Change vs. Log-Jacobian:

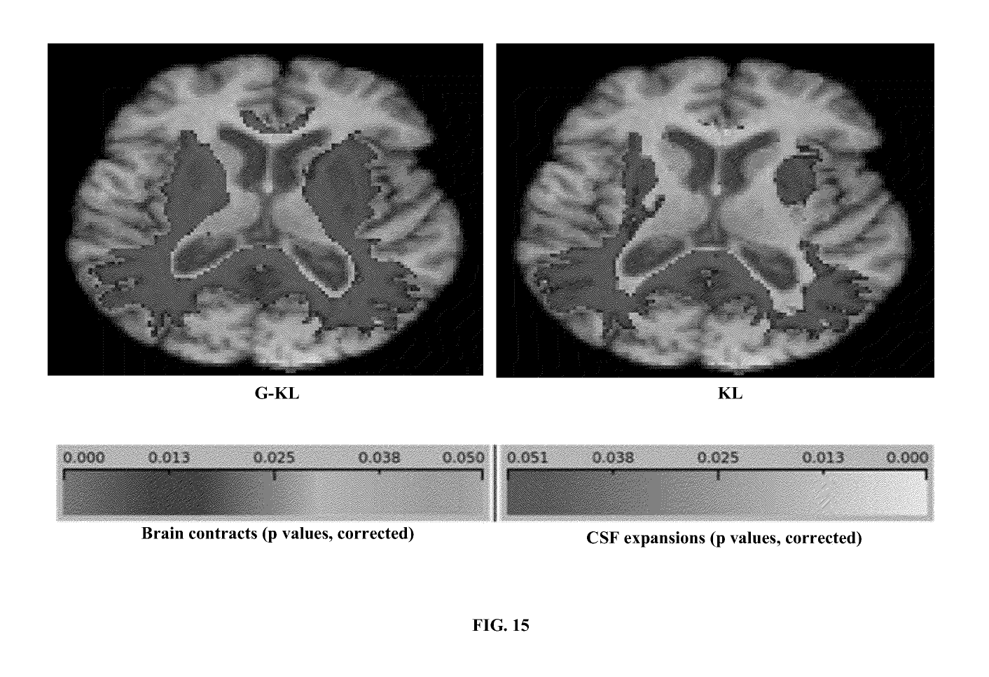

Referring now to FIG. 15, voxelwise significance results for the MMSE change regression for the G-KL and KL methods are depicted. Both algorithms show extensive areas of association between brain tissue loss and MMSE and ventricle expansion with MMSE (all p<0.05, corrected for voxelwise multiple comparisons). G-KL additionally indicates significant associations in anterior cingulate and striatal/putamen regions, not picked up by KL. Correlations in significant areas were quite strong; actual highest t-magnitudes were over 9 for both methods.

B) CSF Beta-Amyloid vs. Log-Jacobian Values:

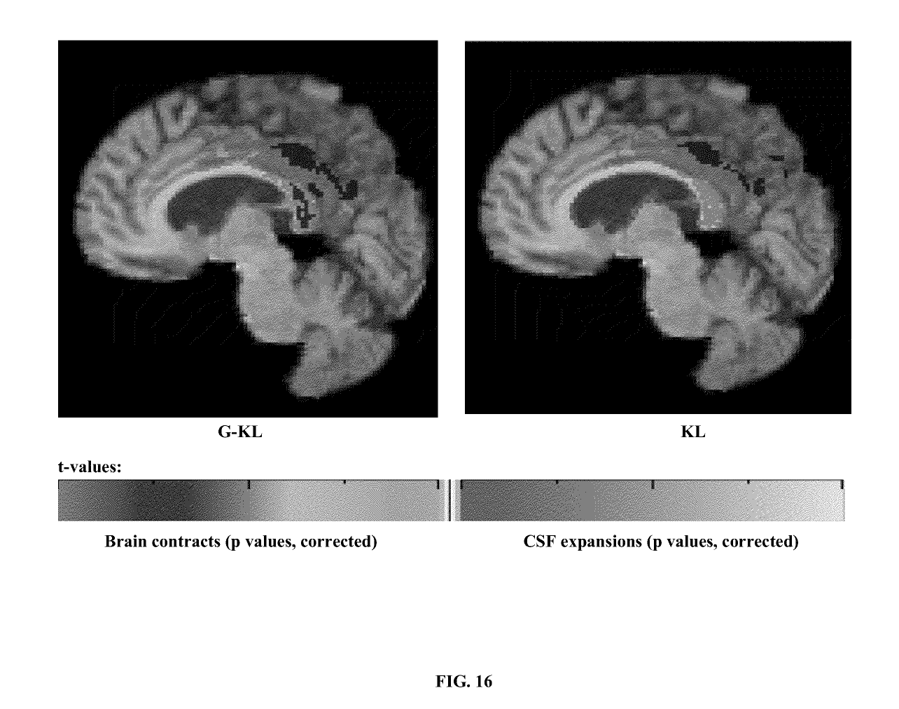

Referring now to FIG. 16, voxelwise cluster significance images for the associate between baseline CSF A-β and log-jacobian for the G-KL and KL methods are depicted. The associations between CSF beta-amyloid and log-Jacobians were much more modest. No significant voxels existed after correction for multiple comparisons; therefore FIG. 16 shows cluster analyses. Both warping models show significant clusters (p<0.05 by cluster size, corrected) posteriorly of relatively weak association (t-thresholds at 2, 3 and 4) between CSF beta-amyloid and brain tissue loss. Both methods also show significant association of ventricular expansion with lower CSF levels of beta-amyloid.

### Example 8

### Clinical Correlations with sROIs

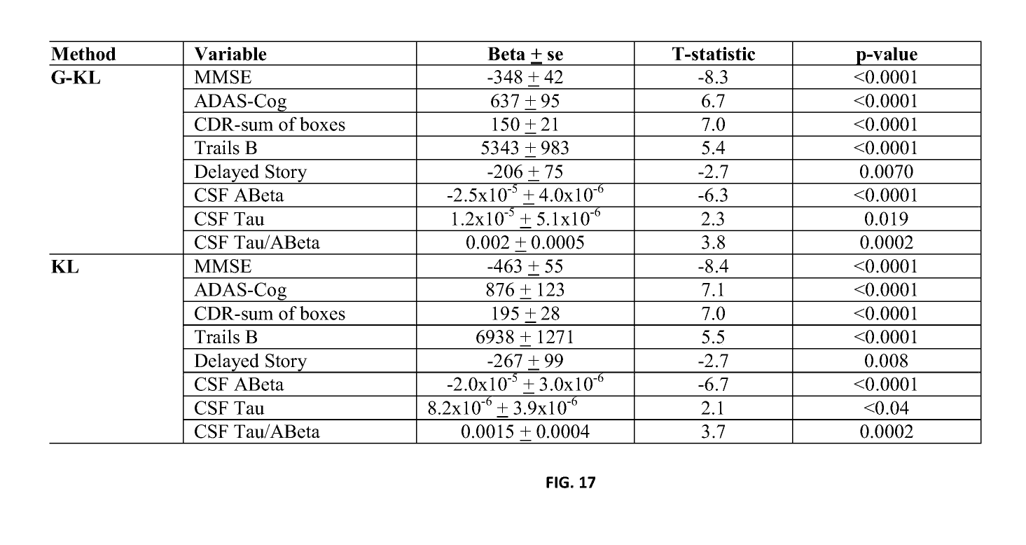

Referring now to FIG. 17, a table summarizing age, education, and gender adjusted associations between cognitive and CSF measures for the G-KL and KL methods is depicted. In general, both methods were highly associated with these various measures.

What is claimed:

1. A method for computing a longitudinal change in a structure of a brain, comprising:
receiving a first image of the brain, wherein the first image is captured at a first time;
receiving a second image of the brain, wherein the second image is captured at a second time;
aligning the first and second images;
generating, using a processor, at least one displacement from a location in the first image back to a corresponding location in the second image; and
determining an optimized matching deformation between the first and second images based on an energy function that incorporates spatially varying estimates of a likelihood of tissue edge presence at the location in the first image, wherein the matching deformation is one of the generated displacements.

2. The method of claim 1, wherein the first and second images are aligned using an optimized linear transformation technique.

3. The method of claim 1, wherein the spatially varying estimates for the likelihood of tissue edge presence are determined based on intensity gradient magnitudes.

4. The method of claim 1, wherein the energy function is comprised of an image-dissimilarity metric and a regularizing penalty term.

5. The method of claim 4, wherein the image-dissimilarity metric uses a cross-correlation formula.

6. The method of claim 5, wherein incorporating the spatially varying estimates for the likelihood of tissue edge presence into the energy function involves inserting a voxel-varying weighting factor derived from estimates of tissue edge presence locations into the cross-correlation formula and into the penalty term, each insertion being inversely proportional to the other.

7. The method of claim 6, wherein optimizing the energy function involves using a fluid-flow technique to solve for a velocity field, wherein the velocity field updates the matching deformation iteratively over one or more increments of time via an Euler integration.

8. The method of claim 6, wherein the penalty term is based on a Kullback-Liebler divergence metric for log-Jacobian distributions with the inserted term based on estimates of edge presence.

9. A system for computing a longitudinal change in a structure of a brain, comprising one or more processors configured to:
receive a first image of the brain, wherein the first image is captured at a first time;
receive a second image of the brain, wherein the second image is captured at a second time;
align the first and second images;
generate, using a processor, at least one displacement from a location in the first image back to a corresponding location in the second image; and
determine an optimized matching deformation between the first and second images based on an energy function that incorporates spatially varying estimates of a likelihood of tissue edge presence at the location in the first image, wherein the matching deformation is one of the generated displacements.

10. The system of claim 9, wherein the first and second images are aligned using an optimized linear transformation technique.

11. The system of claim 9, wherein the spatially varying estimates for the likelihood of tissue edge presence are determined based on intensity gradient magnitudes.

12. The system of claim 9, wherein the energy function is comprised of an image-dissimilarity metric and a regularizing penalty term.

13. The system of claim 12, wherein the image-dissimilarity metric uses a cross-correlation formula.

14. The system of claim 13, wherein incorporating the spatially varying estimates for the likelihood of tissue edge presence into the energy function involves inserting a voxel-varying weighting factor derived from estimates of tissue edge presence locations into the cross-correlation formula and into the penalty term, each insertion being inversely proportional to the other.

15. The system of claim 14, wherein optimizing the energy function involves using a fluid-flow technique to solve for a velocity field, wherein the velocity field updates the matching deformation iteratively over one or more increments of time via an Euler integration.

16. A non-transitory computer-readable medium having instructions stored thereon, wherein the instructions comprise:
instructions to receive a first image of a brain, wherein the first image is captured at a first time;
instructions to receive a second image of the brain, wherein the second image is captured at a second time;
instructions to align the first and second images;
instructions to generate, using a processor, at least one displacement from a location in the first image back to a corresponding location in the second image; and
instructions to determine an optimized matching deformation between the first and second images based on an energy function that incorporates spatially varying estimates of a likelihood of tissue edge presence at the location in the first image, wherein the matching deformation is one of the generated displacements.

17. The non-transitory computer-readable medium of claim 16, wherein the first and second images are aligned using an optimized linear transformation technique.

18. The non-transitory computer-readable medium of claim 16, wherein the spatially varying estimates for the likelihood of tissue edge presence are determined based on intensity gradient magnitudes.

19. The non-transitory computer-readable medium of claim 16, wherein incorporating spatially varying estimates of a likelihood of tissue edge presence improves a statistical significance of the matching deformations of subjects in a pharmaceutical study.

20. The non-transitory computer-readable medium of claim 19, wherein a smaller sample size of the subjects is used in the pharmaceutical study.
